(19) United States
(12) Patent Application Publication
(10) Pub. No.: US 2024/0232112 A1
(43) Pub. Date: Jul. 11, 2024

(54) Dongle Providing Operational Information

(71) Applicant: Marcia M. Darling, Pullman, WA (US)

(72) Inventor: Marcia M. Darling, Pullman, WA (US)

(21) Appl. No.: 18/403,861

(22) Filed: Jan. 4, 2024

Related U.S. Application Data
(60) Provisional application No. 63/437,297, filed on Jan. 5, 2023.

(51) Int. Cl. G06F 13/38

(52) U.S. Cl. CPC G06F 13/385; G06F 2213/0042

(57) ABSTRACT

A device, system and/or method of providing automatic data flow observations visible to a human user during stream transmissions comprising:
providing an electronic device insertable and connectable through a USB port to a computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device;
inserting the dongle into a USB port of a computing device;
the computing device accessing and connecting to the internet;

and when data flow through the dongle meets, exceeds or fails to exceed specific predetermined parameters identified by hardware or software in communication with or embedded in the dongle, the dongle responds to the determination of parameters by providing predetermined distinct LED visible light emission.

### RELATED APPLICATION DATA

This application claims priority as a Continuation-in-Part of U.S. Provisional Patent Application Ser. No. 63/437,297 filed 5 Jan. 2023.

### BACKGROUND OF THE INVENTION

### 1. Field of the Invention

The present invention relates generally to computerized systems and more particularly to dongles used in the connection of computerized systems to the internet.

### 2. Background of the Art

All computer systems, and many related products such as communication devices, printers, storage appliances and more, use a USB (Universal Serial Bus) as the main interface for connecting peripheral hardware.

USB version 1.1 supported two speeds, a full speed mode of 12 Mbits/s and a low speed mode of 1.5 Mbits/s. The 1.5 Mbits/s mode is slower and less susceptible to EMI, thus reducing the cost of ferrite beads and quality components. For example, crystals can be replaced by cheaper resonators. USB 2.0 which is still yet to see day light on mainstream desktop computers has upped the stakes to 480 Mbits/s. The 480 Mbits/s is known as High Speed mode and was a tack on to compete with the Firewire Serial Bus.

USB speeds are typically described as High Speed—480 Mbits/s' Full Speed—12 Mbits/s; and Low speed—1.5 Mbits/s.

The Universal Serial Bus is host controlled. There can only be one host per bus. The specification in itself, does not support any form of multimaster arrangement. However, the On-the-Go specification which is a tack on standard to USB 2.0 has introduced a Host Negotiation Protocol which allows two devices negotiate for the role of host. This is aimed at and limited to single point to point connections such as a mobile phone and personal organizer and not multiple hub, multiple device desktop configurations. The USB host is responsible for undertaking all transactions and scheduling bandwidth. Data can be sent by various transaction methods using a token-based protocol.

The bus topology of USB has been described as somewhat limiting. One of the original intentions of USB was to reduce the amount of cabling at the back of your PC. Apple people will say the idea came from the Apple Desktop Bus, where both the keyboard, mouse and some other peripherals could be connected together (daisy chained) using the one cable.

However, USB uses a tiered star topology, similar to that of 10BaseT Ethernet. This imposes the use of a hub somewhere, which adds to greater expense, more boxes on your desktop and more cables. However, it is not as bad as it may seem.

Many devices have USB hubs integrated into them. For example, your keyboard may contain a hub which is connected to your computer. Your mouse and other devices such as your digital camera can be plugged easily into the back of your keyboard. Monitors are just another peripheral on a long list which commonly have in-built hubs.

This tiered star topology, rather than simply daisy chaining devices together has some benefits. Firstly power to each device can be monitored and even switched off if an overcurrent condition occurs without disrupting other USB devices. Both high, full and low speed devices can be supported, with the hub filtering out high speed and full speed transactions so lower speed devices do not receive them.

Up to 127 devices can be connected to any one USB bus at any one given time. Need more devices?—simply add another port/host. While most earlier USB hosts had two ports, most manufacturers have seen this as limiting and are starting to introduce 4 and 5 port host cards with an internal port for hard disks etc. The early hosts had one USB controller and thus both ports shared the same available USB bandwidth. As bandwidth requirements grew, we are starting to see multi-port cards with two or more controllers allowing individual channels.

The USB host controllers have their own specifications. With USB 1.1, there were two Host Controller Interface Specifications, UHCI (Universal Host Controller Interface) developed by Intel which puts more of the burden on software (Microsoft) and allowing for cheaper hardware and the OHCI (Open Host Controller Interface) developed by Compaq, Microsoft and National Semiconductor which places more of the burden on hardware(Intel) and makes for simpler software. Typical hardware/software engineer relationship.

With the introduction of USB 2.0, a new Host Controller Interface Specification was needed to describe the register level details specific to USB 2.0. Significant Contributors include Intel, Compaq, NEC, Lucent and Microsoft so it would hopefully seem they have pooled together to provide us one interface standard and thus only one new driver to implement in our operating systems. USB 3.0 offers even higher performance and mor rapid connection.

USB as its name would suggest is a serial bus. It uses 4 shielded wires of which two are power (+5v & GND). The remaining two are twisted pair differential data signals. It uses a NRZI (Non Return to Zero Invert) encoding scheme to send data with a sync field to synchronise the host and receiver clocks.

USB supports plug‘n’plug with dynamically loadable and unloadable drivers. The user simply plugs the device into the bus. The host will detect this addition, interrogate the newly inserted device and load the appropriate driver all in the time it takes the hourglass to blink on your screen provided a driver is installed for your device. The end user needs not worry about terminations, terms such as IRQs and port addresses, or rebooting the computer. Once the user is finished, they can simply lug the cable out, the host will detect its absence and automatically unload the driver.

Other standards organisations provide a extra VID for non-commercial activities such as teaching, research or fiddling (The Hobbyist). The USB Implementors forum has yet to provide this service. In these cases you may wish to use one assigned to your development system's manufacturer. For example, most chip manufacturers will have a VID/PID combination you can use for your chips which is known not to exist as a commercial device. Other chip manufacturers can even sell you a PID to use with their VID for your commercial device.

Another more notable feature of USB, is its transfer modes. USB supports Control, Interrupt, Bulk and Isochronous transfers. While we will look at the other transfer modes later, Isochronous allows a device to reserve a defined amount of bandwidth with guaranteed latency. This is ideal in Audio or Video applications where congestion may cause loss of data or frames to drop. Each transfer mode provides the designer trade-offs in areas such as error detection and recovery, guaranteed latency and bandwidth.

(5) A typical server, desktop computer, or laptop will usually have 4 to 6 USB ports that are mostly used for connecting HID products (Human Interface Device) such as a mouse and keyboard, removable media/storage (Disk on Key for example), and other local peripheral hardware devices such as printers, audio input/output/record/playback devices, cameras, scanners etc.

USB is a combined hardware and software specification and is therefore subject to attacks both on the hardware level where an attacker can “transplant” additional hardware functionality into an innocent device, or only add a hostile piece of code (malware) into the device code and then use it to compromise the computer system.

A typical hardware implant scenario is adding wireless transmission capabilities in a mouse or a keyboard, and practically gaining access to the computer system or being able to transmit sensitive information from the computer (ex-filtrate) without the user being aware of or alerted to any change.

A scenario of a firmware/software attack may result from adding the ability of acting as a storage device to an input device, such as a barcode reader, allowing the input device to transfer files into the computer, and infecting the computer with a virus that will steal all credit card information and transmit them at a later time.

Common practice till now has been to whitelist USB devices according to their VID (Vendor ID) and PID (Product ID). This is unfortunate because devices can have “nested” functionality which differs significantly from the original intended and assumed, or ostensible, functionality. For example, when a USB-Audio Microphone is plugged in, it is expected to provide only audio functionality, while in effect such a device could also impersonate a keyboard or a mouse, capable of injecting malicious commands.

The dongle is an intelligent tool with a software protection function provided for an automated software developer, and is a software and hardware combined encrypted product inserted into a parallel port or a USB port of an electronic device. Thus, a software developer can set multiple software locks in software, and open the locks by using the softdog as a key, and if the softdog is not inserted or the softdog does not correspond to the softdog, the software cannot be normally executed.

The traditional dongle is generally directly inserted into a USB interface of the equipment needing to be encrypted, and the dongle is matched with the equipment, so that the dongle can be inserted into the equipment for a long time without being pulled down, but at present, the dongle inserted into the outside of the equipment is easily damaged due to collision, is easily dropped and lost when being externally inserted into the USB interface of the equipment for a long time. A streaming box is essentially a box that you plug directly into your TV, much in the same way you would a standard TV box or games console. Streaming boxes come bundled with remote controls, allowing you to control the box in same way as any other TV remote. Boxes such as this are typically smaller than a standard TV box, as they don't include recording software and don't carry standard TV channels. Users can also purchase dongle versions of their favorite box, which come in the form of a USB stick at the cost of some of the power.

Streaming boxes allow you to stream content from all your favorite streaming platforms without having to buy a smart TV or watch from your computer. Subscription services such as Netflix, Amazon Prime and Now TV are all available to watch on most streaming devices, as well as free video streaming sites such as YouTube. If you're interested in catching the newest shows on Netflix but don't want to be huddled around a laptop, a streaming device is the solution for high-quality, TV viewing.

### Premium Boxes

A number of companies offer boxes that you can plug into your TV and access streaming services. These vary in price depending on who you buy from. Apple TV is one of the more high-profile devices you can buy, and is one that will appeal to those who have bought into the Apple ecosystem. Using this, you can watch shows and listen to music you've purchased on iTunes through your TV, as well as accessing services such as YouTube.

Amazon's Fire TV is another alternative, allowing you to watch shows you've bought via your Amazon account and stream programs from the majority of platforms on offer. Much like Apple TV, Amazon Fire TV allows you to plug the box directly into your TV and get watching, allowing you to pick from a number of different streaming platforms. You'll also be able to access Amazon Prime Video, the company's own video streaming service.

### Plug-In Dongles

Plug-in dongles act as a cheaper and more streamlined version of streaming boxes. Typically resembling your average data stick, streaming dongles connect to your TV's HDMI port just like a standard streaming box, and offer much of the same content for a cheaper price.

One of the most well known streaming dongles available is Google's Chromecast, which allows you to stream content from a number of platforms as well as from Google Play Video, which works in a similar way to iTunes. Chromecast also has the advantage of the ability to control it using an app on your smartphone, therefore getting rid of the need for a bundled remote.

Amazon also has a dongle version of it's Fire TV box available, in the form of the Fire TV Stick. This small device transforms your TV into a smart TV, offering a similar amount of speed and power as the standard box whilst being much smaller and cheaper. Using the Fire TV Stick, users will be able to access services such as BBC iPlayer, Netflix, Spotify and obviously Amazon Prime Video.

A streaming dongle is a small movie or image or image/audio streaming device that plugs into an HDMI port on a TV or A/V receiver and accepts digital media wirelessly from mobile devices, computers or the Internet. Not much larger than a flash drive, Roku, Amazon and Google make such devices

Among the types of functions that may be run through the dongle (or by what ever other name one applies to the device) are streaming, security analysis, instrument control (as in medical procedures) and any other information transmission functions. Examples of such functions and the supportive hardware and software are known in the art, as shown below. All cited documents are incorporated herein by reference.

All documents referenced herein are incorporated in their entireties by reference.

U.S. Pat. No. 11,544,416 (Appleboum) discloses a System and Method For Securing A Computer System From Threats Introduced By USB Devices. US Patent No. 11,475,536 discloses context-aware synthesis for video frame interpolation.

U.S. Pat. Nos. 11,475,536 and 11,468,318 (Liu) various streaming processes. Included are processes in which instead a novel grid network.

U.S. Pat. No. 11,465,029 (Wanke) discloses streamed content using Systems, Devices, And Methods Employing The Same For Enhancing Audience Engagement In A Competition Or Performance. The platform includes a client application program downloadable to a mobile device or other processing device. The program may include a database storing a mobile device identifier (ID), a user ID, user information, and location data of the device. The application may further be configured to display one or more events of the activity as well as an input for receiving a score of the activity from the user. The platform may additionally include a server system connected with the client application programs via a communication network. The server system may be configured for receiving the mobile device ID, the user ID, the user information, and the location data for the client program, and may further be configured to receive the scores from the users, and to adjust the scores according to determined bias of the associated user.

U.S. Pat. No. 11,437,043 (Lizhen) is of interest as the present invention devices may limit locations for utilization of computers by identifying presence of specific authorized locations or users, first signaling questions about those parameters and then shutting down the device if additional information indicates an impropriety.

U.S. Pat. No. 10,664,772 (Poel) discloses a Method And System For Facilitating Collaboration Sessions. As these may be streamed sessions, the device of the present invention operating as a streaming dongle is particularly appropriate. Additionally, as done on some websites (e.g., boardgamearena.com), the dongle of the present invention may have functionality enabling limitation or non-limitation of responders online, such as defining a specific targeted group, such as friends, personnel of specific origin (.gov, company devices, etc.), which can be governed by a touchscreen on the dongle, original programming, subsequent programming (as through an FPGA (field programmable gated array), or passage through specific encryption requirements on the dongle of the present invention.

In this vein, U.S. Pat. No. 10,592,924 (Cronin) supports Managing Third Party Interactions With Venue Communications. In operation, these systems and methods for managing third party interactions with event venue communications are provided. Incoming communications may be received from a third party device and stored in a database. Each communication may be associated with one or more parameters. When the parameters associated with a specified communication are determined to have been met, one or more targets are identified for the specified communication. Such identified targets may be associated with a particular communications hub that may be provided with the specified communication to direct to the identified targets.

U.S. Pat. No. 11,381,551 (Thomas) discloses Systems and Methods for Connecting Private Devices to Public Devices According to Connection Parameters. When a media guidance application receives a communication requesting to use the public device from a private device that is implementing a private interface application (e.g., Netflix™ a streaming media application), the device of the present invention may facilitate a response in which the media guidance application may generate an authorization key that is unique to the private device and comprises connection parameters. The media guidance application may transmit the authorization key to the private interface application to initiate a session between the public device and the private device. Whenever a command is received from the private device, the media guidance application may verify the authorization key and determine whether the connection parameters are satisfied. In response to verifying the authorization key and the connection parameters, the public device may execute the received command.

### SUMMARY OF THE PRESENT INVENTION

An electronic device is insertable and connectable through a USB port to a computing device. The electronic device may be defined as a dongle or streaming dongle and may have content including hardware and software therein, and at least two LEDs emitting visible radiation. The device or dingle has at least one exterior surface on which or through which emitted visible radiation from the at least two LEDs can be viewed outside of the computing device. Upon execution of software in the dongle, response by hardware and/or software in the dongle causes a distinct type of LED visible light emission. This distinct type of light emission may be selected from the group consisting of different patterns, colors, sequences or duration of emitted display of at least one LED. The distinct response may be based on input information sensed by the hardware or software resulting from data transmission through the dongle.

### BRIEF DESCRIPTION OF THE FIGURES

FIG. 1 is a perspective view of a dongle.

FIG. 2 shows internal structure of a dongle.

FIG. 3 is a flow diagram of practices of the present invention.

FIG. 4 is a schematic of the inventive system in operation.

### DETAILED DESCRIPTION OF THE PRESENT INVENTION

An electronic device is insertable and connectable through a USB port to a computing device. The electronic device may be defined as a dongle or streaming dongle and may have content including hardware and software therein, and at least two LEDs emitting visible radiation. The device or dingle has at least one exterior surface on which or through which emitted visible radiation from the at least two LEDs can be viewed outside of the computing device. Upon execution of software in the dongle, response by hardware and/or software in the dongle causes a distinct type of LED visible light emission. This distinct type of light emission may be selected from the group consisting of different patterns, colors, sequences or duration of emitted display of at least one LED. The distinct response may be based on input information sensed by the hardware or software resulting from data transmission through the dongle.

A method of providing automatic data flow observations visible to a human user during stream transmissions comprising:
providing an electronic device insertable and connectable through a USB port to a computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle;
inserting the dongle into a USB port of a computing device;
the computing device accessing and connecting to the internet;
and when data flow through the dongle meets, exceeds or fails to exceed specific predetermined parameters identified by hardware or software in communication with or embedded in the dongle, the dongle responds to the determination of parameters by providing predetermined distinct LED visible light emission.

The electronic device may have at least three distinct and physically separated LEDs emitting visible radiation, the dingle having at least one exterior surface on which or through which emitted visible radiation from the at least three LEDs can be viewed outside of the computing device. Depending on the sophistication of signals needed and to be provided, 2-100, 3-100, 4-100, or other numbers of LEDs may be provided.

The electronic devices of the invention may be used on any device wherein the port engagement (typically USB, any variation or grade) is compatible with the insert head of the device, meaning also that the interconnectivity of the head of the electronic device and the port are acceptable.

The form or sense of the distinct LED visible light emission is responsive to identification of any number of parameters with respect to functionality of data flow through the dongle. Among the more obvious parameters are state of data flow through the dongle (not merely on-off, but also degree of buffering, signal strength, signal format, source format, source code, encryption requirements, password requirements, ID requirements, and the like).

The electronic device may provide different and distinct LED visible light emissions when a stable internet connection had been established and when an internet connect is or becomes unstable. Among the different and distinct emissions are, by way of non-limiting examples, numbers of lights, colors of lights, patterns and location of lights, frequency of lights, etc.

The electronic device may also have a touchscreen present on at least one exterior surface of the dongle and execution of software in the dongle causes a distinct touchscreen visible light emission selected from the group consisting of different patterns, colors, sequences or duration of emitted display on the touchscreen based on information sensed by the hardware or software resulting from data transmission through the dongle. The touchscreen may actually replace in whole or in part the LED lights. Such a touchscreen would touch sensitive at specific locations thereon to initiate a response to touch altering activity within the dongle. The electronic device may have the multiple or at least the three LEDs emit visible light at different positions on the electromagnetic spectrum which differ by at least 70 nm from each other. Wavelength emission spacing becomes cramped with more than 10 different color emitters, where the spacing would drop to an average of at least 30-40 nanometers between emitted colors.

The following commentary in this disclosure indicates various aspects of practice that may or may not be exercised.

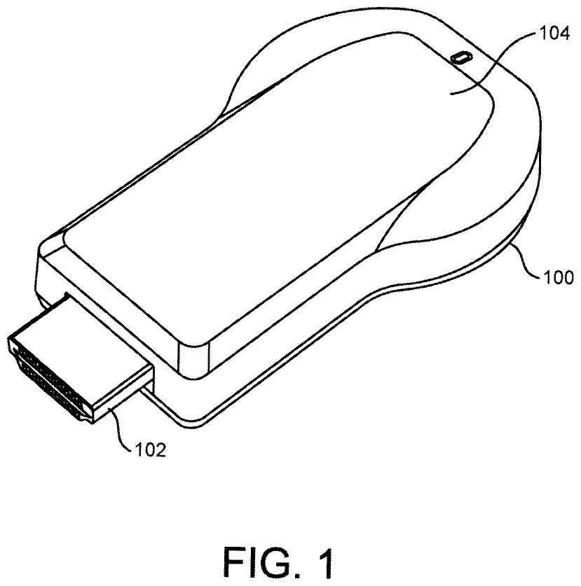

FIG. 1 is a perspective view of a dongle 100. The USB port connector 102 and an exterior surface 104 where LEDs or touchscreen may be placed (not shown) is identified. The placement may be on the surface, in the surface, or beneath a surface having sufficient transparency or translucency to allow transmission through it.

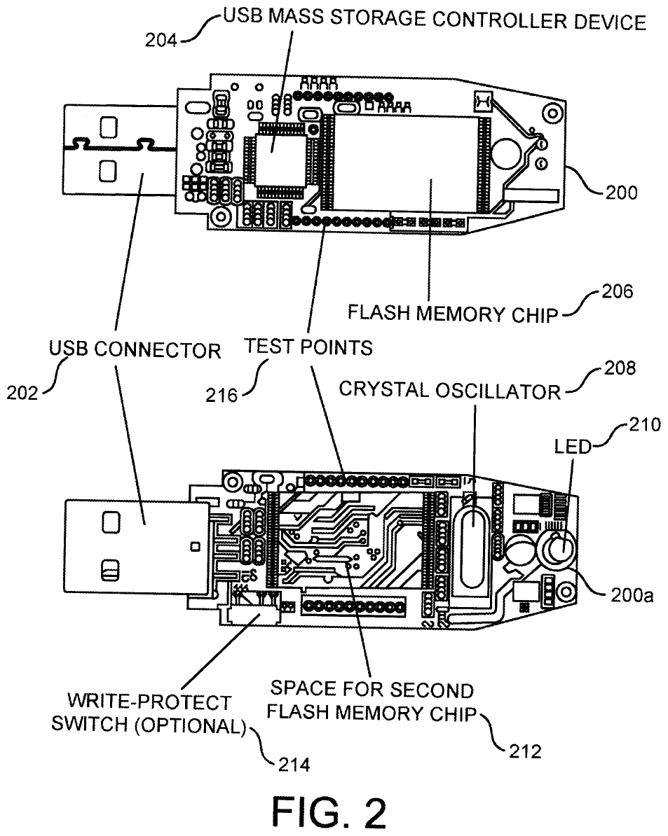

FIG. 2 shows two views of internal structure of a prior art dongle as a memory device 200 200a. The USB port connector 202, USB mass storage controller device 204, flash memory chip 206, crystal oscillator 208, a typical LED to indicate on-off or activity during memory access in the device, space for a second flash memory chip 212, optional write-protect switch 214, and test points 216.

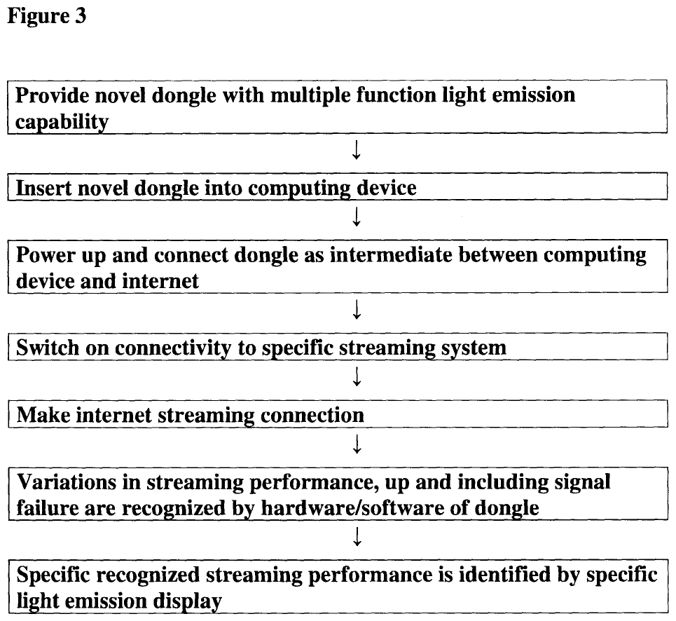

FIG. 3 is a flow diagram indicating one mode of operation of the dongle device of the present invention in a method step. The step are self-explanatory.

The switch operates as a toggle to turn the broadcast livestream on and off. In addition, we will have other switches, either physically or on the touchscreen, for switching scenes in the software. (e.g., Going from a scene where a video games takes up 90% of the screen and the host's webcam takes up 10% to a scene where the webcam takes up the full field of view).

In some embodiments, public device and the private device may not be compatible. For example, the public device may be a public display with a Windows™-based operating system and the private device may be a smartphone with an iOS™-based operating system. In some cases, the two respective devices may be unable to communicate due to their differences in programming. As a result, the media guidance application may determine that the private device is of a first operating system type and the public device is of a second operating system type. The media guidance application may determine that the first operating system type is incompatible with the second operating system type. In response to receiving a first message (e.g., command, request, data packet) that is encoded using the first operating system type by the private interface application and is to be sent to the public device, the media guidance application may translate the content of the first message and generate a second message encoded using the second operating system type that includes the content of the first message. The media guidance application may then record the first message in a log and may transmit the second message to the public device.

A media guidance application may request, from the private device, both user authorization information and an identifier for the private interface application. In response to the user making a selection of the public device, the media guidance application may create a temporary connection between the private device and the public device. The temporary connection may allow the private device and the public device to communicate without providing access to the functionality of either device (e.g., the ability to access and display the content). Accordingly, the private device may receive, from either the public device or a remote server with the media guidance application, a request for user authorization information and an identifier of the private interface application. The user authorization information may comprise data required to verify the user's identity with the content provider. For example, the user authorization information may list the subscriptions the user possesses and the respective login keys (e.g., username, password, security questions, PIN codes, etc.) to access the subscriptions. The identifier of the private interface application may be any descriptive attribute of the private interface application including, but not limited to, a name, a logo, a developer name, software details (e.g., build number, version, compatible operating system), a screenshot of the user interface, etc. It should be noted that the identifier may comprise a combination of descriptive attributes. For example, an identifier may include the name of a content provider (e.g., Netflix™) associated with the private interface application, the version of the private interface application (e.g., version 5.6), and the compatible operating systems (e.g., iOS™, Android™). Thus, in this example, the identifier that the private device may provide to the public device is “Netflix™, Android™ application version 5.6.” It should be noted that the content provider may be a third-party source (e.g., Google™ Play Store, App Store) as well.

In some embodiments, the user authorization information may be stored on a server. A public device may scan the user's face and/or fingerprint and run facial/fingerprint recognition analysis using a facial/fingerprint database that may be stored on the server. In response to identifying a match, the media guidance application may retrieve the user authorization information associated with the match.

A media guidance application may then generate, at the public device, an authorization key unique to the private device based on (i) the user authorization information, (ii) the identifier and (iii) connection parameters, wherein the authorization key is required to cause the public device to execute commands received from the private device during a session. Continuing from the previous example, suppose that the identifier for the private interface application is “Netflix™, Android™ application version 5.6.” The user authorization information may thus comprise a username and password to the user's Netflix™ account. The connection parameters represent conditions that must be met in order to maintain the connection between the public device and the private device. For example, the connection parameters may comprise a predetermined proximity to the public device, within which the private device must remain in order for the authorization key to remain valid. The connection parameters may comprise restrictions on certain commands that the user may request. For example, the user may request that the public device perform a task that demands heavy processing as it requires high-end graphics (e.g., the command may be to generate for display a video game). In this example, the public device cannot generate for display the video game because the requirements of the video game exceed the public device's technical capabilities. For example, the public device may have limitations in CPU processing power, memory, graphics (e.g., resolution), or connectivity (e.g., network bandwidth). In the absence of connection parameters, the public device may get damaged while trying to generate for display the video game (e.g., may cause corrupted files and/or overheating at the motherboard).

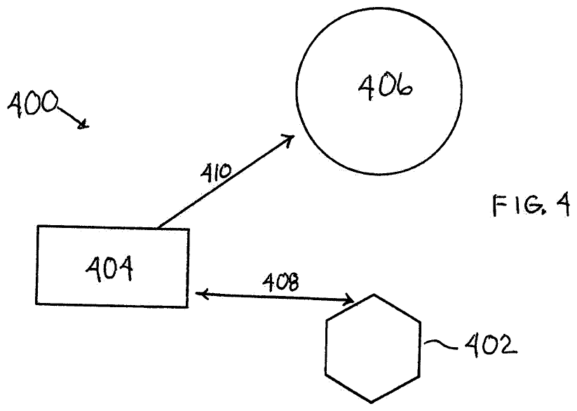

FIG. 4 is a schematic of the inventive system 400 in operation. The StreamPad™ connectivity dongle of the present invention 402 is shown in two-way 408 communication with a processing device 404, typically with wifi connectivity (see below re PCI, PC card, CF. etc.) and a port (e.g., USB port, preferably at least a USB3 port) although wi-fi connectivity or hardwire connectivity may be used. The processing device 404 has broadcast capability 410 into the online universe 406. The StreamPad™ dongle connects via to an external computer 404 using live broadcasting software. It has a button/switch (e.g., for on/off control) and LED light indicators, further providing status indicators. When the button/switch is pressed, it sends a signal to the streaming software (in the computer/processing device 404 to start or cease broadcasting a livestream (See FIG. 4). As the dongle 402 receives a signal detailing the status of the stream, The StreamPad™ connectivity device changes colors of lights on the dongle to indicate the status of the stream (e.g., blinking red=standby, solid blue=booting up, solid green=live broadcast, etc.).

The StreamPad™ device is a novel configuration of hardware and software in a single component that enables people to livestream and gives current streamers better access to the status of their stream. The embedded software is as simple to set up as possible. And with just one button, the hardware is designed to be simple to use and easy to understand. Plug in the StreamPad™ device, turn it on, and it self-executes to connect the computing device 404 to connect with the streaming or broadcast online universe.

Accordingly, the dongle of the present invention, acting also as a media guidance application may take the public device's technical capabilities into consideration and limit the user to commands that the public device can implement, information about which may be included in the connection parameters.

Similarly, the dongle of the present invention may identify and indicate any issues regarding connection parameters, which may include information such as the connection type (e.g., Wi-Fi, cellular data, etc.) established between the private device and public device, the location of the respective devices, time limits for accessing the public device (e.g., allow the connection between the public device and the private device for one hour only), etc. The authorization key may be encrypted by symmetric and/or public/private encryption method. This provides security and prevents other devices from sending commands on behalf of the private device. An example of an authorization key may be “AUTH:username-password_ID:identifier_PARA:parameters.” Therefore, if the username of a user is “user123,” the password is “pass123,” the identifier is “Netflix™, Android™ application version 5.6,” and the connection parameters include a predetermined proximity, the private device serial number, public device serial number, connection type, minimum data transfer rate, and time limit (e.g., 5m-private123-public321-bluetooth-100 kbps-60 min), the authorization key in its entirety may be “AUTH: user123-pass123_ID: Netflix™[ Android™M, v5.6]_PARA:5m-private 123-public321-bluetooth-100 kbps-60 min.”

In some embodiments, the user may not need to provide user authorization information because the user may be interested in accessing a publicly accessible application on the public device. For example, if the user possesses a cellphone that does not have smartphone features, the user may wish to read the news, look up the weather, or browse the Internet. Accordingly, the user may not be able to perform those tasks on the private device and also does not need authorization information to pull up the user's profile (e.g., Netflix™ account with preferences). Thus, when the media guidance application requests user authorization information, the user may not provide user authorization information. In response, the media guidance application may not include user authorization information in the authorization key (e.g., leave the text after “AUTH” empty).

The dongle of the present invention may also then operate as a media guidance application to transmit, to the private device, the authorization key and in response to transmitting the authorization key, the media guidance application may initiate a session, at the public device, with the private device. The session may be a formal connection between the public device and the private device in which commands can be exchanged between the respective devices. The formal connection may be established over various communication infrastructures including, but not limited to, Wi-Fi, Bluetooth, cellular networks, wired connections (e.g., Ethernet), etc. It should be noted that the authorization key is required to execute commands, at the public device, received from the private device during the session.

In this capacity, the dongle of the present invention acting also as a media guidance application may then receive, at the public device, a first communication from the private interface application. The media guidance application may parse, at the public device, the first communication to identify the authorization key and a command to execute on the public device. The command is a task that the user assigns to the public device. Furthermore, the command may be associated specifically with the private interface application. For example, if the private interface application is a video streaming application such as the Netflix™ mobile app, the user may initiate a first communication with the public device by sending a command that requests that the public device download a public interface application (e.g., a corresponding Netflix™ application) that is compatible with the private interface application. The command may also be to change a setting of the public device (e.g., increase volume, decrease brightness, etc.). The commands may be transmitted as text from the private device to the public device, verbally from the user to the public device, via gestures or any visual indication of a command from the user/private device to the public device, or biometric changes (e.g., changes in heart rate, tightening of muscles, etc.). It should be noted that not all public devices may have displays (e.g., smart speakers, augmented reality devices, hologram generators, etc.). For those particular public devices, an appropriate user interface that is compatible with the public device and allows user interaction via the private interface application may be used. Based on the examples listed above, these substitute user interfaces may be an audio user interface (e.g., where a menu is read aloud to the user), augmented reality user interface (e.g., allows the user to see an augmented reality screen via the private device), or a holographic projection user interface (e.g., where the menu is projected). In some embodiments, the private interface application and/or the public interface application may be browser-based (e.g., implemented in HTMLS).

The dongle of the present invention acting also as a media guidance application may then validate, at the public device, the authorization key.

Validating the authorization key may involve two steps: (1) determining whether the authorization key received from the private device matches the authorization key transmitted by the public device to the private device and (2) determining whether the connection parameters are satisfied. For example, the media guidance application may store a copy of the authorization key for a threshold time (e.g., three minutes) when transmitting the authorization key to the private device. Thus, the private device must send a command within the threshold time before the media guidance application erases the authorization key from the memory of the public device. In response to receiving a command (e.g., as a first communication), the media guidance application may decrypt the authorization key at the public device and determine whether the received authorization key matches the authorization key in the memory of the public device. If the respective authorization keys match, the media guidance application may determine whether the connection parameters of the authorization key are satisfied (e.g., whether the connection type is the same, the data transfer rate is locked to a threshold speed, the private device is within the predetermined proximity, the time elapsed within the time limit, etc.). If the received authorization key matches and each connection parameter is satisfied, the media guidance application may validate the authorization key. In response to validating the authorization key, the media guidance application may execute, at the public device, the command. For example, the command may be to generate for display, on the public device, a media asset selected on the private interface application (e.g., a movie selected on the Netflix™ mobile application).

The dongle of the present invention acting in communication with Control circuitry may be based on any suitable processing circuitry such as processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry executes instructions for a media guidance application stored in memory (i.e., storage). Specifically, control circuitry may be instructed by the media guidance application to perform the functions discussed above and below. For example, the media guidance application may provide instructions to control circuitry to generate the media guidance displays. In some implementations, any action performed by control circuitry may be based on instructions received from the media guidance application.

In client-server based embodiments, control circuitry may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as storage that is part of control circuitry in the connected processing device or computer. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage may be used to store various types of content described herein as well as media guidance data described above. Nonvolatile memory may also be used (e.g., to launch a boot-up routine and other instructions). Cloud-based storage may be used to supplement storage or instead of onboard storage.

Control circuitry may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry may also include scaler circuitry for upconverting and down-converting content into the preferred output format of the user equipment.

Circuitry may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage is provided as a separate device from user equipment, the tuning and encoding circuitry (including multiple tuners) may be associated with storage.

A user may send instructions to control circuitry using user input interface. User input interface may be any suitable user interface, such as a remote control, mouse, trackball, keypad, keyboard, touch screen, touchpad, stylus input, joystick, voice recognition interface, or other user input interfaces. Display may be provided as a stand-alone device or integrated with other elements of user equipment device. For example, the display may be a touchscreen or touch-sensitive display. In such circumstances, user input interface may be integrated with or combined with display. Display may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display may be HDTV-capable or UHDTV-capable. In some embodiments, display may be a 3D display, and the interactive media guidance application and any suitable content may be displayed in 3D. A video card or graphics card may generate the output to the display. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry. The video card may be integrated with the control circuitry. Speakers may be provided as integrated with other elements of user equipment device or may be stand-alone units. The audio component of videos and other content displayed on display may be played through speakers. In some embodiments, the audio may be distributed to a receiver (not shown), which processes and outputs the audio via speakers.

The applications of the present invention may be implemented using any suitable architecture. For example, it may be a stand-alone application wholly-implemented on user equipment device. In such an approach, instructions of the application are stored locally (e.g., in storage), and data for use by the application is downloaded on a periodic basis (e.g., from an out-of-band feed, from an Internet resource, or using another suitable approach). Control circuitry may retrieve instructions of the application from storage and process the instructions to generate any of the displays discussed herein. Based on the processed instructions, control circuitry may determine what action to perform when input is received from input interface. For example, movement of a cursor on a display up/down may be indicated by the processed instructions when input interface indicates that an up/down button was selected.

In some embodiments, the application of the invention is a client-server based application. Data for use by a thick or thin client implemented on user equipment device is retrieved on-demand by issuing requests to a server remote to the user equipment device. In one example of a client-server based guidance application, control circuitry runs a web browser that interprets web pages provided by a remote server. For example, the remote server may store the instructions for the application in a storage device. The remote server may process the stored instructions using circuitry (e.g., control circuitry) and generate the displays discussed above and below. The client device may receive the displays generated by the remote server and may display the content of the displays locally on equipment device. This way, the processing of the instructions is performed remotely by the server while the resulting displays are provided locally on equipment device. Equipment device may receive inputs from the user via input interface and transmit those inputs to the remote server for processing and generating the corresponding displays. For example, equipment device may transmit a communication to the remote server indicating that an up/down button was selected via input interface. The remote server may process instructions in accordance with that input and generate a display of the application corresponding to the input (e.g., a display that moves a cursor up/down). The generated display is then transmitted to equipment device for presentation to the user.

In some embodiments, the application of the invention is downloaded and interpreted or otherwise run by an interpreter or virtual machine (run by control circuitry). In some embodiments, the guidance application may be encoded in the ETV Binary Interchange Format (EBIF), received by control circuitry as part of a suitable feed, and interpreted by a user agent running on control circuitry. For example, the guidance application may be an EBIF application. In some embodiments, the guidance application may be defined by a series of JAVA-based files that are received and run by a local virtual machine or other suitable middleware executed by control circuitry. In some of such embodiments (e.g., those employing MPEG-2 or other digital media encoding schemes), the guidance application may be, for example, encoded and transmitted in an MPEG-2 object carousel with the MPEG audio and video packets of a program.

### StreamPad™ Dongle Interface Instructions Interfacing via PUTTY on Windows

PUTTY is a popular and secure SSH, Telnet, and SFTP client for Windows. It is typically used for remote access to server computers over a network using the SSH protocol. Download the installation package from the master download site and follow the instructions for installation and setup. PuTTY is a communications tool for running interactive command-line sessions on other computers, usually via the SSH protocol. It can also communicate over a serial port, or speak various legacy Internet protocols such as Telnet. PuTTY is free software, licensed under the MIT license. The Secure Shell Protocol (SSH) is a cryptographic network protocol for operating network services securely over an unsecured network. Its most notable applications are remote login and command-line execution. SSH applications are based on a client-server architecture, connecting an SSH client instance with an SSH server. The following provides non-limiting examples of the exercise of steps in the use of the StreamPad™ dongle.
1. Use (for example) a Micro-USB cable to plug the button into the computer
2. Identify the COM Port of the button
   1. Launch Device manager by pressing start, typing “Device Manager” and pressing enter
   2. Expand “Ports (COM and LPT)
   3. Look for “Silicon Labs CP210x USB to UART Bridge” and make note of the COM port (e.g., COM3)
3. Launch PUTTY
4. Configure PUTTY as follows
   1. Under “Terminal”
      1. Set Local echo: Force On
      2. Set local line editing: force On
   2. Under “Session”
      1. select radio button next to “Serial”
      2. Set Serial line to the Com Port previously identified
      3. Set speed to 115200
      4. If desired, enter a name under Saved Sessions, and click “Save” to store these settings for future use.
5. Click “Open”
6. Enter commands described by “available commands” section. Note: backspace has no effect. If a typing error is made, press enter, and start entering the command again.

### Interfacing Via Code

1. Use (for example) a Micro-USB cable to plug the button into the computer
2. Prompt for a com port, or search available com ports for identifier “Silicon Labs CP210x USB to UART Bridge”
3. Open the com port with the following settings
   1. Speed/Baud rate: 115200
   2. Data bits: 8
   3. Stop Bits: 1
4. Write ASCII commands described in “available commands” section to the com port. Commands must be terminated with a new-line character.
5. Monitor incoming data from COM port. (see section on Button Behavior)

### Button Behavior

Every time the button is pressed, it sends the character “s” through the COM port, followed by a new line character. A button press will cause the character “s” followed by a new-line character to be sent through the COM port. Normally, no other data will be sent, but this should not be relied upon, as various errors will cause the button to transmit descriptive data through the COM port

### Available Commands

Note: each command needs to be followed by a new line character to be executed. If using PuTTY, and you configured as described in “Interfacing via PUTTY on Windoes”, new line character will be added automatically when you press enter
R sets button's LED to red
same as using: rgb 255 0 0
G sets button's LED to green
same as using: rgb 0 255 0
B sets button's LED to blue
same as using: rgb 0 0 255
rgb or RGB [redVal] [green Val] [blue Val]
sets button color to specified RGB value.
[redVal], [green Val], and [blue Val] need to be whole numbers between 0 and 255 e.g., to set teal: rgb 0, 255, 255
off turns off LED on button
f [onTime] [offTime] [cycles] Will cause the led to flash off 0, 1, or more times.
[offTime] defines time in ms is off when it turns off (max: 2\hat{ }31−1)
[onTime] defines time in ms the led is on between off flashes (max: 2\hat{ }31−1)
[cycles] defines the total number of times to flash the led (max: 2\hat{ }31−1)
cycles=0 causes any currently running flash behavior to stop, and led reverts to last set value
cycles<0 causes led to flash continuously
note: using color setting commands will change the on color of the flashing, but
will not otherwise change the flash pattern
f [redVal] [green Val] [blue Val] [onTime] [offTime] [cycles]
Will cause led to flash between current color and another color [redVal], [green Val], [blueVal]: intensity of red, green, blue LEDs respectively. (range 0-255)
[onTime]: how long in ms the specified color is lighted for (max: 2\hat{ }31−1)
[offTime]: how long in ms the original color is lighted for between flashes (max: 2\hat{ }31−1)
[cycles]: how many times to flash the color. cycles=0 will stop any current flashing and led will revert to last set value. cycles<0 will cause led to flash continuously.
note: using color setting commands will change the off color of the flashing, but will not otherwise change the flash pattern.

To support mobile applications, computer devices are often small, making them practical for people to carry with them at all times. These devices generally have small screens, limited keyboards, and small batteries. The devices are mobile, but they can support only certain applications. With portable and stationary applications, however, the computer devices are much larger. These devices generally have larger displays and keyboards, making them more suitable to use when browsing the Internet and other applications requiring relatively high performance. Computer devices within a wireless network also include end systems such as servers, databases, and websites.

Users can adapt many existing computer devices to operate on a wireless network. A user, for example, can purchase and install a wireless network interface card (NIC) within his laptop to enable operation on a particular type of wireless network. Some devices, such as a wireless bar code scanner, operate only on a wireless network. Among the several types of Network Interface Cards (NICs) are PCI's (peripheral interface cards), PC (Personal Computer card) cards and CF's (Compact Flashes). Wireless NICs also comply with a specific form factor, which defines the physical and electrical bus interface that enables the card to communicate with the computer device. Again, the user must consider this to ensure that the chosen wireless NIC will fit within their computer device.

A computer device also has an operating system, such as Windows (any version), LINUX, or MAC OS (any version). The operating system runs software needed to realize the wireless network application. In some cases, the operating system has built-in features that enhance wireless networks. For example, Windows XP has the ability to automatically identify and associate with wireless LANs.

### NICs

The network interface card provides the interface between the computer device and the wireless network infrastructure. The NIC fits inside the computer device, but external network adaptors are available that plug in and remain outside the computer device.

The following claims are intended to be expressions of generic concepts and the use of specific terms are to be interpreted broadly.

What is claimed:

1. An electronic device insertable and connectable through a port to a computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle.

2. The electronic device of claim 1 wherein there are at least three LEDs emitting visible radiation, the dingle having at least one exterior surface on which or through which emitted visible radiation from the at least three LEDs can be viewed outside of the computing device.

3. The electronic device of claim 2 wherein the distinct LED visible light emission is responsive to identification of a state of data flow through the dongle.

4. The electronic device of claim 3 wherein the dongle emits different distinct LED visible light emissions when a stable internet connection had been established and when an internet connect is or becomes unstable.

5. The electronic device of claim 1 wherein a touchscreen is present on at least one exterior surface of the dongle and execution of software in the dongle causes a distinct touchscreen visible light emission selected from the group consisting of different patterns, colors, sequences or duration of emitted display on the touchscreen based on information sensed by the hardware or software resulting from data transmission through the dongle.

6. The electronic device of claim 6 wherein the touchscreen is touch sensitive at specific locations thereon to initiate a response to touch altering activity within the dongle.

7. The electronic device of claim 2 wherein the at least three LEDs emit visible light at different positions on the electromagnetic spectrum which differ by at least 70 nm from each other.

8. The electronic device of claim 1 wherein the electronic device is connectable through a USB port.

9. The electronic device of claim 3 wherein the electronic device is connectable through a USB port.

10. The electronic device of claim 5 wherein the electronic device is connectable through a USB port.

11. The electronic device of claim 17 wherein the electronic device is connectable through a USB port.

12. A method of providing automatic data flow observations visible to a human user during stream transmissions comprising:
providing an electronic device insertable and connectable through a port to a computing device, the electronic device further comprising a dongle having hardware and software therein, and at least two LEDs emitting visible radiation, the dongle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle;
inserting the dongle into the port of a computing device;
the computing device accessing and connecting to the internet;
and when data flow through the dongle meets, exceeds or fails to exceed specific predetermined parameters identified by hardware or software in communication with or embedded in the dongle, the dongle responds to the determination of parameters by providing predetermined distinct LED visible light emission.

13. The method of claim 12 wherein the electronic device is connected to the computing device through a USB port.

14. The method of claim 13 wherein data for use by a thick or thin client implemented on the computing device is retrieved on-demand by issuing requests to a server remote to the computing device.

15. The method of claim 14 wherein data for use by a thick or thin client implemented on the computing device is retrieved on-demand by issuing requests to a server remote to the computing device.

16. The method of claim 13 executed on an electronic device inserted and connected through a port to the computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle.

17. The method of claim 14 executed on an electronic device inserted and connected through a port to the computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle.

18. The method of claim 15 executed on an electronic device inserted and connected through a port to the computing device, the electronic device further comprising a dongle having hardware and software therein, and at least two LEDs emitting visible radiation, the dingle having at least one exterior surface on which or through which emitted visible radiation from the at least two LEDs can be viewed outside of the computing device; and further wherein execution of software in the dongle causes a distinct LED visible light emission selected from the group consisting of different patterns, colors, sequences or duration of emitted display of at least one LED based on information sensed by the hardware or software resulting from data transmission through the dongle.
